(19) United States
(12) Patent Application Publication
(10) Pub. No.: US 2018/0307954 A1
(43) Pub. Date: Oct. 25, 2018

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Masaaki OYAIDE, Izu Shizuoka (JP)

(73) Assignees: KABUSHIKI KAISHA TOSHIBA, Tokyo (JP); TOSHIBA TEC KABUSHIKI KAISHA, Tokyo (JP)

(21) Appl. No.: 15/681,837

(22) Filed: Aug. 21, 2017

(30) Foreign Application Priority Data
Apr. 21, 2017 (JP) 2017-084775

(51) Int. Cl. G06K 15/00; B41J 2/045; G06F 3/12

(52) U.S. Cl. CPC G06K 15/4065; B41J 2/0452; G06F 3/1265; G03G 2215/00599; G06F 3/1252

(57) ABSTRACT

An image forming apparatus includes an input section, an image forming section, and a controller. The input section inputs a command for executing printing on a sheet. The image forming section forms an image using a recording agent on the sheet based on the command input by the input section. The controller controls the image forming section to print a predetermined number of sheets among all pages subjected to the printing according to a printing command and executes the printing on the remaining pages after a predetermined continuation condition is satisfied if the printing command input by the input section corresponds to a specific printing condition.

### CROSS-REFERENCE TO RELATED APPLICATION

This application is based upon and claims the benefit of priority from Japanese Patent Application No. 2017-084775, filed Apr. 21, 2017, the entire contents of which are incorporated herein by reference.

### FIELD

Embodiments described herein relate generally to an image forming apparatus.

### BACKGROUND

If a printing condition such as a paper size is set by mistake in a case of executing printing on a plurality of sheets, there is a case in which a large amount of printing is wasted. Specifically, it is possible to execute the printing using a special sheet or a special toner in recent years. Thus, if a large amount of such a printing is executed by mistake, there is a possibility of wasting much cost.

### DESCRIPTION OF THE DRAWINGS

FIG. 1 is a diagram exemplifying the overall arrangement of an image forming apparatus 1 according to an embodiment;

FIG. 2 is a diagram illustrating a specific example of a control panel 20;

FIG. 3 is a schematic block diagram illustrating main functional components of the image forming apparatus 1;

FIG. 4 is a diagram illustrating a specific example of a display on the control panel 20; and

FIG. 5 is a flowchart illustrating a specific example of the flow of the operation of the image forming apparatus 1.

### DETAILED DESCRIPTION

In accordance with an embodiment, an image forming apparatus comprises an input section, an image forming section, and a controller. The input section inputs a command for executing printing on a sheet. The image forming section forms an image using a recording agent on the sheet based on the command input by the input section. The controller controls the image forming section to print a predetermined number of sheets among all pages subjected to the printing according to a printing command and executes the printing on the remaining pages after a predetermined continuation condition is satisfied if the printing command input by the input section corresponds to a specific printing condition.

Hereinafter, an image forming apparatus of an embodiment is described in detail with reference to the accompanying drawings.

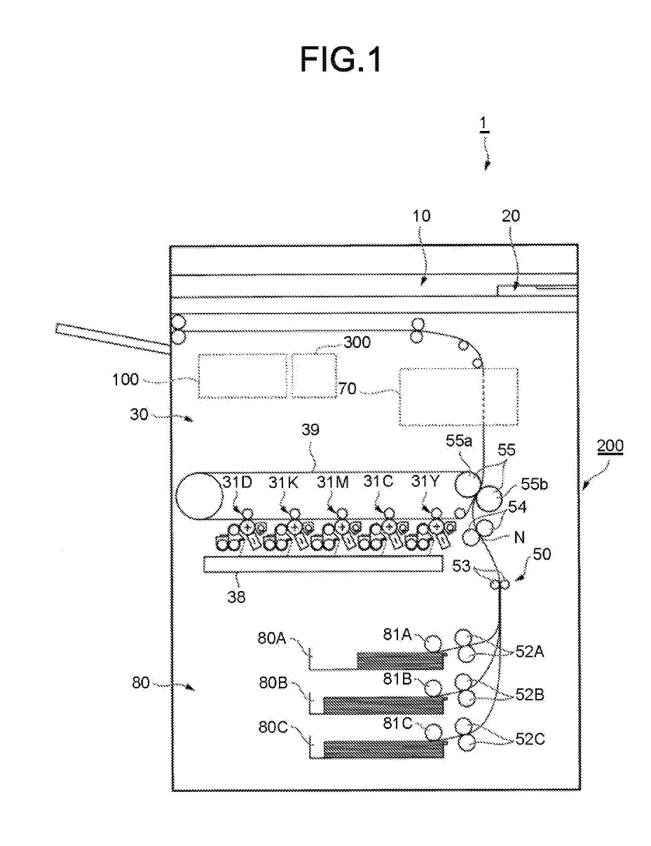

FIG. 1 is a diagram exemplifying the overall arrangement of an image forming apparatus 1 according to an embodiment.

The image forming apparatus 1 of the embodiment is an MFP (Multi-Function Peripheral). The image forming apparatus 1 executes an image forming processing. The image forming processing is a processing of forming an image on a sheet using a recording agent. The sheet is, for example, a general paper, a label paper, or a special sheet. The special sheet is a sheet with a higher cost than the general sheet (hereinafter, referred to as a “normal sheet”). The special sheet is, for example, a sheet on which a glossy film is processed, a sheet on which waterproofing is executed, or a sheet on which magnetic processing is executed. The image forming processing may be executed using a special recording agent. The special recording agent is a recording agent with a higher cost than a general recording agent (for example, black toner). The special recording agent is, for example, a recording agent requiring a high time cost to obtain and a recording agent with high monetary cost, such as a recording material with limited frequency of use or a recording material used for a special purpose. The special recording agent is, for example, a decolorable recording agent, a brilliant recording agent (for example, a golden or silver recording agent), a fluorescent recording agent, or an aromatic recording agent. The decoloring in the present embodiment means making an image formed with a color (including not only a chromatic color but also an achromatic color such as white and black) different from a color of a ground of the sheet visually invisible. The decoloring may be executed by a method other than decoloring by heating.

The image forming apparatus 1 includes an image reading section 10, a control panel 20, an image forming section 200, a communication section 300 and a controller 100. In the present embodiment, the image forming apparatus 1 uses the toner to form an image; however, the image forming apparatus 1 may be an inkjet type apparatus.

The image reading section 10 reads image information which is a reading object as intensity of light. The image reading section 10 records the read image information. The recorded image information is output to the controller 100.

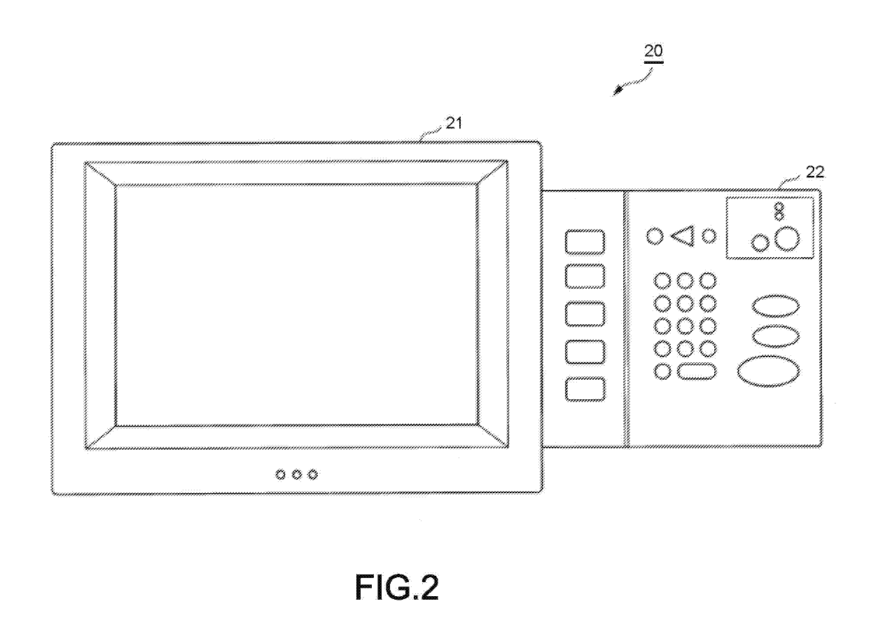

The control panel 20 is a user interface. FIG. 2 is a diagram illustrating a specific example of the control panel 20. The control panel 20 includes a display section 21 and an operation section 22. The display section 21 is a liquid crystal display or an organic EL (Electro Luminescence) display. The display section 21 displays various information relating to the image forming apparatus 1. The display section 21 may display buttons to be operated by a user. The operation section 22 includes an input device such as a plurality of buttons. The operation section 22 receives an operation by the user. The user inputs a command relating to printing through the operation section 22. The operation section 22 outputs a signal corresponding to the operation executed by the user to the controller 100. The control panel 20 may be constituted using a touch panel formed by the display section 21 and the operation section 22 integrally. The display section 21 may be constituted as a touch panel.

The communication section 300 is an interface for communicating with an external terminal. Through the communication section 300, for example, the image forming apparatus 1 communicates with a personal computer for sending an image to be printed or a printing command such as the number of sheets to be printed or toner to be used to the image forming apparatus 1. The communication section 300 is, for example, a network interface such as a wired LAN port.

Either one or both of the communication section 300 and the control panel 20 correspond to the input section.

The image forming section 200 includes a printer section 30, a conveyance section 50, a fixing section 70, and a sheet housing section 80.

The printer section 30 executes the image forming processing. In the image forming processing, the printer section 30 executes the image forming processing in response to a print command from the communication section 300 or the control panel 20. The image is formed on the sheet based on image information generated by the image reading section 10 or image information received from an external terminal via the communication section 300. The printer section 30 in the present embodiment uses a toner which is the special recording agent (hereinafter, referred to as a “special toner”) and a toner which is a general recording agent (hereinafter, referred to as a “normal toner”). The normal toner is, for example, a black (K) toner.

The printer section 30 executes either the image forming processing with the normal toner or the image forming processing with the special toner under the control of the controller 100. In the following description, the image forming processing with the normal toner is described as a normal printing, and the image forming processing with the special toner is described as a special printing.

The sheet housing section 80 includes a plurality of sheet feed cassettes 80A, 80B and 80C. Each of the sheet feed cassettes 80A, 80B and 80C stores a sheet of a predetermined size and type. For example, the sheet feed cassettes 80A and 80B house the general sheets and the sheet feed cassette 80C houses the special sheet. The sheet feed cassettes 80A, 80B and 80C have pickup rollers 81A, 81B and 81C, respectively. Each of the pickup rollers 81A, 81B and 81C picks up the sheets one by one from each of the sheet feed cassettes 80A, 80B and 80C. The pickup rollers 81A, 81B, and 81C supply the picked sheets to the conveyance section 50.

The conveyance section 50 conveys the sheet picked up from the sheet housing section 80 to a sheet discharge section. The conveyance section 50 includes a sheet feed roller 52A, a sheet feed roller 52B, a sheet feed roller 52C, a conveyance roller 53, and a resist roller 54. The sheet feed rollers 52A, 52B and 52C convey the sheet supplied by the pickup rollers 81A, 81B and 81C to the resist roller 54. The resist roller 54 conveys the sheet to a transfer section 55 side according to a timing at which the transfer section 55 of the printer section 30 described later transfers a toner image onto the surface of the sheet. The resist roller 54 conveys the sheet to the transfer section 55 side after aligning a front end of the sheet sent by the conveyance roller 53 at a nip N.

These various rollers are driven by a roller driving section 90. The roller driving section 90 is a driving device such as a motor. The roller driving section 90 rotates the pickup roller and rollers provided in the conveyance section 50 by generating a driving force if receiving the supply of electric power. Through the driving by the roller driving section 90, the sheet is picked up by the pickup roller 81 and the sheet is conveyed in the conveyance section 50.

The controller 100 controls the operation of the image forming apparatus 1. The detailed description of the controller 100 is described later.

Next, the detailed arrangement of the printer section 30 is described. The printer section 30 includes a developing section 31, an exposure section 38, an intermediate transfer belt 39, the transfer section 55 and the fixing section 70. The developing section 31 has predetermined kinds of toner. In the following description, a developing section corresponding to yellow (Y) toner is described as a developing section 31Y, a developing section corresponding to magenta (M) toner is described as a developing section 31M, a developing section corresponding to cyan (C) toner is described as a developing section 31C, a developing section corresponding to the black (K) toner is described as a developing section 31K, and a developing section corresponding to the special toner is described as a developing section 31D.

Each developing section 31 (31Y, 31M, 31C, 31K or 31D) supplies a developer in a developer housing section to a photoconductive drum. The developer housing section houses the developer. The developer is a mixture of a carrier composed of magnetic fine particles and each toner. If the developer is stirred, the toner is triboelectrically charged. Thus, the toner adheres to a surface of the carrier by electrostatic force. In the developer housing section, a first mixer, a second mixer, a developing roller, and a temperature and humidity sensor are arranged. The first mixer and the second mixer stir the developer. The first mixer and the second mixer convey the developer. The second mixer is arranged below the developing roller.

The second mixer supplies the developer housed in the developer housing section to the surface of the developing roller. The temperature and humidity sensor detects temperature and humidity of the inner side of the developer housing section as a state of the printer section 30.

The developing roller rotates counterclockwise by the driving of a developing motor. The developing roller is composed of a magnetic material (magnet) in which negative electrodes and positive electrodes are arranged alternately in a circumferential shape. The developer supplied by the second mixer brushes up on the surface of the developing roller according to a magnetic field distribution of the developing roller. As the developing roller rotates, the napped developer contacts the surface of the photoconductive drum in a sweeping manner. The magnetic field distribution of the developing roller is switchable. The developing section 31 switches the magnetic field distribution of the developing roller to execute napping and ear-breaking of the developer. The developing roller is connected to a voltage applying circuit. Under the control of the controller 100, the voltage applying circuit applies a voltage as a developing bias to the developing roller. The voltage applied to the developing roller is, for example, a negative DC voltage.

The photoconductive drum has a photoconductive layer on a surface thereof. The photoconductive drum rotates clockwise by the driving of the developing motor. Around the photoconductive drum, the developing section 31, a charging section, a discharging section, a cleaning unit and a transfer roller are arranged.

The charging section uniformly charges the surface (photoconductive layer) of the photoconductive drum. For example, the charging section charges the surface (photoconductive layer) of the photoconductive drum to negative polarity. As a result, a toner image is formed on the surface (photoconductive layer) of the photoconductive drum according to an electrostatic latent image.

For example, the developing section 31Y develops the electrostatic latent image on the surface (photoconductive layer) of the photoconductive drum with the yellow (Y) toner. The developing section 31M develops the electrostatic latent image on the surface of the photoconductive drum with the magenta (M) toner. The developing section 31C develops the electrostatic latent image on the surface of the photoconductive drum with the cyan (C) toner. The developing section 31K develops the electrostatic latent image on the surface of the photoconductive drum with the black (K) toner. The developing section 31D develops the electrostatic latent image on the surface of the photoconductive drum with the special toner.

The cleaning unit scrapes off the toner that is not transferred on the surface of the photoconductive drum to remove it. The cleaning unit removes the toner on the surface of the photoconductive drum after the toner image is transferred from the photoconductive drum onto the intermediate transfer belt 39. The toner removed by the cleaning unit is collected in a waste toner tank to be discarded.

The discharging section faces the photoconductive drum across the cleaning unit. The discharging section illuminates the surface of the photoconductive drum with the light. As a result, the heterogeneous charge on the photoconductive layer becomes uniform. In other words, the charge of the photoconductive layer is removed.

The transfer roller faces the photoconductive drum across the intermediate transfer belt 39. The transfer roller abuts against the surface of the photoconductive drum across the intermediate transfer belt 39. The transfer roller transfers (primarily transfers) the toner image on the surface of the photoconductive drum onto the intermediate transfer belt 39.

The exposure section 38 is arranged at a position facing the photoconductive drum of each of the developing sections 31Y, 31M, 31C, 31K and 31D. The exposure section 38 irradiates the surface of the photoconductive drum of each of the developing sections 31Y, 31M, 31C, 31K and 31D with the laser light. The exposure section 38 is controlled to emit the light based on the image data under the control of the controller 100. The exposure section 38 emits the laser light based on the image data. In this way, the negative charge on the surface of the photoconductive drum of each of the developing sections 31Y, 31M, 31C, 31K and 31D is eliminated. As a result, a static electricity pattern is formed at a position irradiated with the laser light on the surface of the photoconductive drum. By irradiation of the laser light by the exposure section 38, the electrostatic latent image is formed on the surface of the photoconductive drum. In the exposure section 38, an LED (Light Emitting Diode) light may be used instead of the laser light.

The fixing section 70 has a heating roller having a heat source and a pressure roller for applying heat and pressure to the sheet. The fixing section 70 fixes the toner image transferred onto the sheet on the sheet by the heat and pressure.

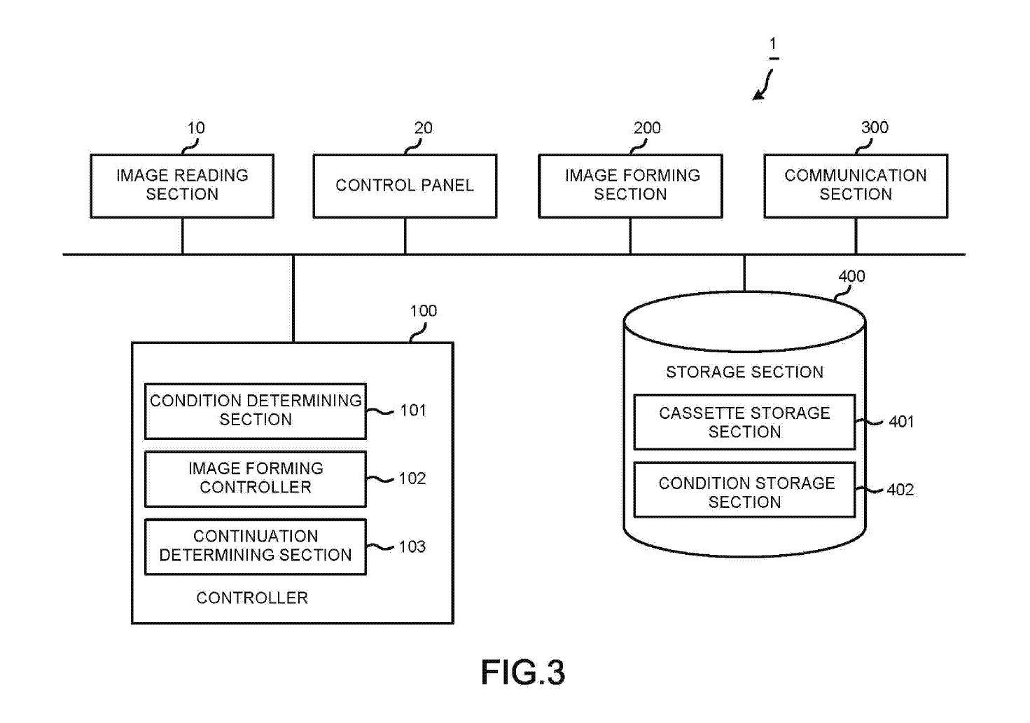

FIG. 3 is a schematic block diagram illustrating main functional components of the image forming apparatus 1. The image forming apparatus 1 includes the image reading section 10, the control panel 20, the controller 100, the image forming section 200, the communication section 300 and a storage section 400.

The description of the printer section 30, the roller driving section 90 and the communication section 300 is omitted as it is the same as that described above.

The controller 100 is constituted by a CPU (Central Processing Unit) and a memory. The controller 100 functions as a condition determining section 101, an image forming controller 102 and a continuation determining section 103 by executing a program stored in the memory by the CPU.

The condition determining section 101 acquires an image forming instruction by the user. The image forming instruction may be received from an information processing apparatus operated by the user via the communication section 300. The image forming instruction may be acquired according to an operation result of the user on the control panel 20. The image forming instruction contains printing conditions. The printing conditions include information indicating the type of the recording agent used for image formation, information indicating the type of sheet used for image formation, the number of copies to be formed, the number of pages for a part of image formation, and information such as a type and presence or absence of a post-processing. In this case, “part” is not a word indicating a part of the whole, but a word indicating a unit of printing (for example, a unit of one document).

The information indicating the type of the sheet may be information directly indicating the type of the sheet or information indicating the cassette in which the sheet is stored. The condition determining section 101 determines whether or not a specific printing condition is satisfied based on the printing condition in the acquired image forming instruction. The specific printing condition is a condition for forming an image on a plurality of sheets (two or more sheets) and indicating that image formation requiring relatively high cost is executed. The specific printing condition may be set by the user of the image forming apparatus 1 or preset by the designer of the image forming apparatus 1. The specific printing condition is stored in the storage section 400. A concrete example of the specific printing condition is described below.

The specific printing condition may be, for example, that the image formation is executed on the special sheet. Specifically, what sheet the special sheet is may be set by the user or may be preset by the designer as described above. As specific examples of sheets that can become the special sheet, a sheet on which the glossy film processing is executed, a sheet on which the waterproof processing is executed, and a sheet on which the magnetic processing is executed are exemplified.

The specific printing condition may be, for example, that the image formation is executed using the special recording agent. Specifically, what kind of recording agent the special recording agent is may be set by the user or may be preset by the designer as described above. As specific examples of recording agents that can become the special recording agent, the decolorable recording agent, the brilliant recording agent (e.g., golden or silver color recording agent), the fluorescent recording agent, and the aromatic recording agent are exemplified.

The specific printing condition may be, for example, that the special recording agent is used for image formation on the special sheet.

If determining that the predetermined printing condition is satisfied, the condition determining section 101 instructs the image forming controller 102 to execute a confirmation printing processing. On the other hand, if determining that the predetermined printing condition is not satisfied, the condition determining section 101 instructs the image forming controller 102 to execute a continuous printing processing.

The image forming controller 102 controls the printer section 30 and the roller driving section 90 to execute the image forming processing according to the image forming instruction designated by the user. The image on which the image forming processing is executed by the image forming controller 102 may be received from another information processing apparatus via the communication section 300 or may be image information read by the image reading section 10. The image forming controller 102 controls the roller driving section 90 to drive the pickup roller 81 according to the type of the sheet in the image forming instruction. Next, the image forming controller 102 controls the developing section 31, the exposure section 38, the intermediate transfer belt 39 and the transfer section 55 in such a manner that an image by the recording agent corresponding to the image forming instruction is transferred onto the sheet. The image forming controller 102 then controls the fixing section 70 to pressurize and heat the sheet onto which the image is transferred. Meanwhile, the image forming controller 102 controls the roller driving section 90 to drive rollers in the conveyance section 50 as needed.

If the execution of the continuous printing processing is instructed by the condition determining section 101, the image forming controller 102 executes the image formation consecutively for the total number of copies according to the number of copies and the number of pages included in the image forming instruction. For example, if the image formation of 10 pages and 5 copies per one job is instructed, the image formation of 50 pages is executed consecutively.

If the execution of the confirmation print processing is instructed by the condition determining section 101, the image forming controller 102 switches to a standby state after executing the image forming processing on a predetermined number of sheets among total number of sheets corresponding to the number of copies and the number of pages included in the image forming instruction. The predetermined number of sheets may be, for example, a predetermined ratio (for example, 10%, 20%, etc.) of the total number of pages. For example, the predetermined number of sheets may be the number of pages from a page on which the image formation using the special recording agent is executed to a predetermined number (for example, 1, 5, etc.) of pages. For example, the predetermined number of sheets maybe the number of pages from a page on which the image formation for the special sheet is executed to a predetermined number (for example, 1, 5, etc.) of sheets.

The image forming controller 102 interrupts the image forming processing if switching to the standby state. If receiving the continuation instruction from the continuation determining section 103, the image forming controller 102 executes the image forming processing on the remaining pages. If receiving a cancellation instruction from the continuation determining section 103, the image forming controller 102 terminates the interrupted image forming processing without executing the image forming processing on the remaining pages. In this case, the image forming processing is not executed until the image forming instruction is input again.

The continuation determining section 103 determines whether or not a condition (hereinafter, referred to as a “continuation condition”) for executing subsequent image formation is satisfied if the image forming controller 102 switches to the standby state. The continuation condition is that the continuation instruction is made by the user, for example. The continuation instruction may be made, for example, via the control panel 20. The continuation instruction may be made, for example, in an information processing apparatus operated by the user. In this case, the continuation instruction is received via the communication section 300. The continuation condition may be that a predetermined time elapses without making an instruction (cancellation instruction) indicating that the image formation is canceled after switching to the standby state. The continuation determining section 103 outputs the continuation instruction to the image forming controller 102 if the continuation condition is satisfied. On the other hand, the continuation determining section 103 outputs the cancellation instruction to the image forming controller 102 if the cancellation instruction is made.

The storage section 400 is constituted using a storage device such as a magnetic hard disk device or a semiconductor storage device. The storage section 400 functions as a cassette storage section 401 and a condition storage section 402.

The cassette storage section 401 stores information indicating which kind of sheet is stored in one or a plurality of cassettes provided in the image forming apparatus 1. For example, in the present embodiment, information is stored in the cassette storage section 401 which indicates that the sheet feed cassette 80A stores the general sheet of A4-R, the sheet feed cassette 80B stores the general sheet of A4, and the sheet feed cassette 80C stores the special sheet of A4-R.

The condition storage section 402 stores the specific printing condition subjected to the condition determination by the condition determining section 101. The specific printing condition stored by the condition storage section 402 may be registered in advance by the developer of the image forming apparatus 1 or may be registered or updated by the user.

The communication section 300 is a communication interface. The communication section 300 executes data communication with another device via a wireless communication path or a priority communication path. For example, the communication section 300 may receive the image forming instruction from another device.

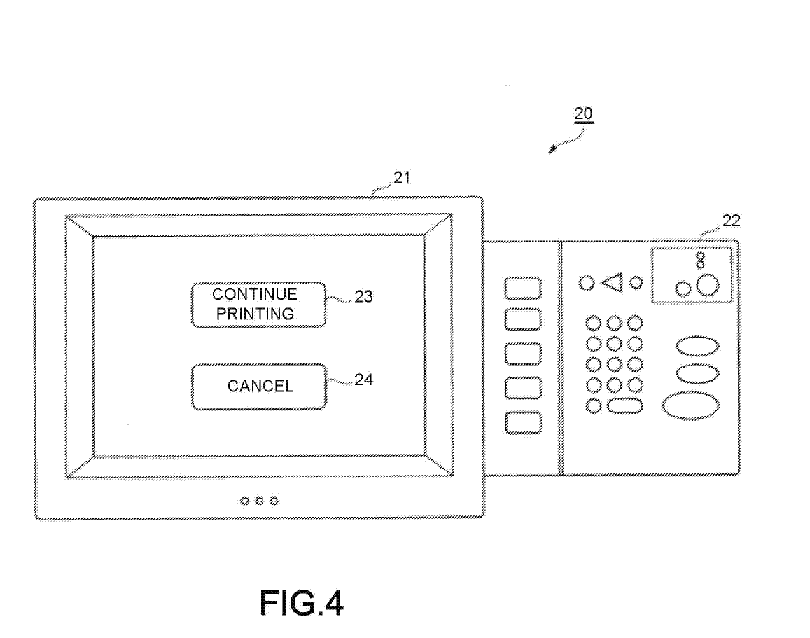

FIG. 4 is a diagram illustrating a specific example of display on the control panel 20. In a display section 21 of the control panel 20, a continuation instruction button 23 and a cancel button 24 are displayed. The continuation instruction button 23 displays characters “continue printing”. If the continuation instruction button 23 displayed on the display section 21 is operated, the continuation determining section 103 of the controller 100 determines that the continuation condition is satisfied. If the cancel button 24 displayed on the display section 21 is operated, the continuation determining section 103 of the controller 100 determines that the cancellation instruction is input.

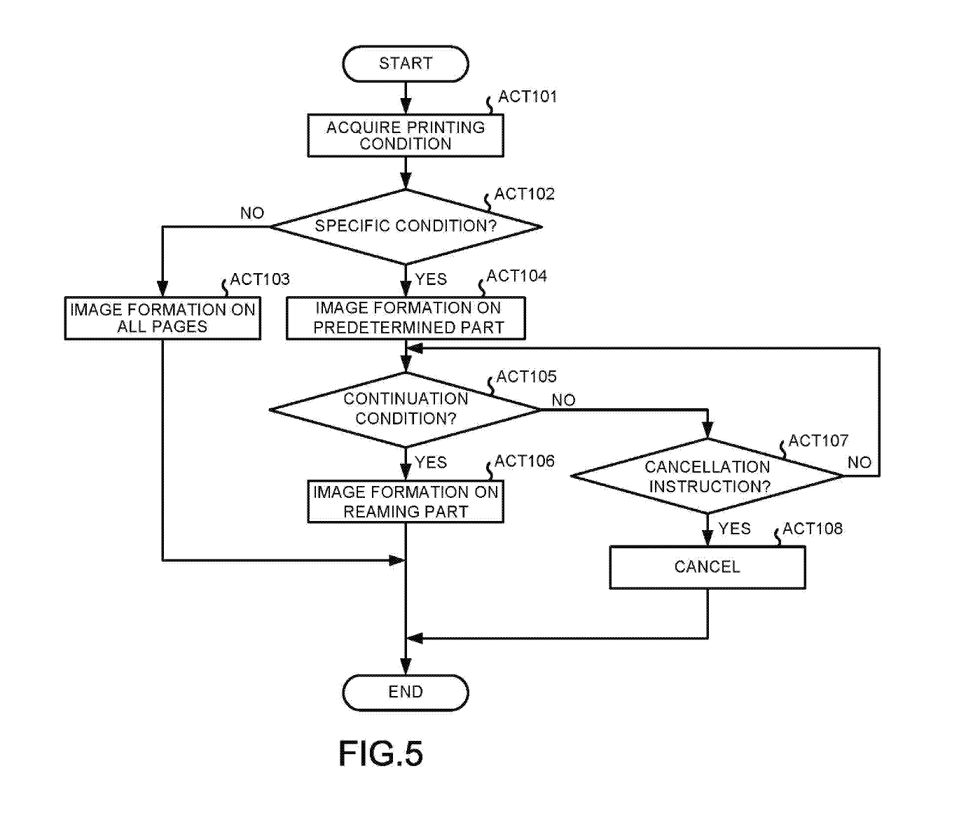

FIG. 5 is a flowchart illustrating a specific example of the flow of the operation of the image forming apparatus 1. First, the condition determining section 101 acquires the printing condition designated by the user (ACT 101). The condition determining section 101 determines whether or not the acquired printing condition satisfies the specific condition (ACT 102). If the specific condition is not satisfied (NO in ACT 102), the condition determining section 101 instructs the image forming controller 102 to execute the continuous printing processing. In this case, the image forming controller 102 consecutively executes the image forming processing for all the pages in response to the instruction of the continuous printing processing (ACT 103).

On the other hand, if the printing condition satisfies the specific condition (YES in ACT 102), the condition determining section 101 instructs the image forming controller 102 to execute the confirmation printing processing. In this case, the image forming controller 102 executes the image forming processing only for a predetermined number of sheets (ACT 104) in response to the instruction of the confirmation printing processing. Thereafter, the continuation determining section 103 determines whether or not the continuation condition is satisfied (ACT 105). If the continuation condition is satisfied (YES in ACT 105), the continuation determining section 103 instructs the continuation instruction to the image forming controller 102. In response to the continuation instruction, the image forming controller 102 executes the remaining image forming processing that is not executed in the image forming processing in the ACT 104 (ACT 106).

On the other hand, if the continuation condition is not satisfied and the cancellation instruction is input by the user (NO in ACT 105, YES in ACT 107), the continuation determining section 103 outputs the cancellation instruction to the image forming controller 102. In this case, the image forming controller 102 does not execute the remaining image forming processing and ends the interrupted image forming processing (ACT 108). The continuation determining section 103 waits until the continuation condition is satisfied or the cancellation instruction is input (NO in ACT 105, NO in ACT 107).

In the image forming apparatus 1 arranged as described above, it is possible to reduce unnecessary cost due to setting of erroneous printing conditions, and the effect is described in detail below.

In the image forming apparatus 1, if the image forming instruction satisfying the specific printing condition is received from the user, the confirmation printing processing is executed without receiving any other special instructions. The image forming instruction satisfying the specific condition refers to an instruction of forming an image on a plurality of sheets while requiring relatively high cost. Therefore, if an instruction to form an image on a plurality of sheets having a relatively high cost is required is input, the image formation is executed on not all of the pages but a part thereof and then interrupted. The user can determine whether or not the printing condition set by himself/herself is correct by looking at the sheet on which the image is formed before the interruption. Unlike determination by looking at a setting screen of the printing, since it is possible to make determination by actually looking at the sheet on which the image formation is executed, it is possible to determine whether the printing condition is correct or not more accurately. If the printing condition is erroneous by any chance, the printing can be canceled by image formation until the time point of interruption. Therefore, it is possible to prevent the image formation from being executed on all pages with the erroneous printing condition, and it is possible to reduce the occurrence of unnecessary cost.

If the specific printing condition is satisfied, the confirmation printing processing is executed without needing a clear instruction from the user. Therefore, for example, even if the user erroneously misses the check of “printing for a part” by any chance, the user can notice that by confirming the printing result (whether only the same page is printed).

### (Modification)

The special recording agent may include a color recording agent. For example, toner of each color of YMC may be used as the special recording agent.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
an input section configured to input a command for executing printing on a sheet;
an image forming section configured to form an image using a recording agent on the sheet based on the command input by the input section;
a controller configured to control the image forming section to print a predetermined number of sheets among all pages subjected to the printing according to a printing command and to execute the printing on the remaining pages after a predetermined continuation condition is satisfied when the printing command input by the input section corresponds to a specific printing condition.

2. The image forming apparatus according to claim 1, wherein
the predetermined number of sheets is the number of pages from the beginning to the middle of the pages in a part indicating a unit of printing.

3. The image forming apparatus according to claim 1, wherein
the predetermined number of sheets is the number of pages accounting for a predetermined ratio of all the pages which are printing objects.

4. The image forming apparatus according to claim 1, wherein
the predetermined number of sheets is the number of pages from a page on which image formation using a special recording agent is executed to a predetermined number of pages.

5. The image forming apparatus according to claim 1, wherein
the predetermined number of sheets is the number of pages from a page on which image formation on a special sheet is executed to a predetermined number of pages.

6. The image forming apparatus according to claim 1, wherein the controller is configured to control the image forming section to perform continuous printing processing of all pages subjected to the printing when a specific printing condition is not satisfied.

7. The image forming apparatus according to claim 1, wherein the controller is configured to control the image forming section to cancel the printing on the remaining pages when the predetermined continuation condition is not satisfied.

8. The image forming apparatus according to claim 7, wherein the controller is configured to determine that the predetermined continuation condition is not satisfied based on a cancellation command input by the input section.

9. The image forming apparatus according to claim 7, wherein the controller is configured to determine that the predetermined continuation condition is not satisfied based on a predetermined lapse time having been exceeded.

10. An image forming process, comprising:
inputting a command for executing printing on a sheet;
forming an image using a recording agent on the sheet based on the command input;
printing a predetermined number of sheets among all pages subjected to the printing according to a printing command and executing the printing on the remaining pages after a predetermined continuation condition is satisfied when the printing command input corresponds to a specific printing condition.

11. The process according to claim 10, wherein
the predetermined number of sheets is the number of pages from the beginning to the middle of the pages in a part indicating a unit of printing.

12. The process according to claim 10, wherein
the predetermined number of sheets is the number of pages accounting for a predetermined ratio of all the pages which are printing objects.

13. The process according to claim 10, wherein
the predetermined number of sheets is the number of pages from a page on which image formation using a special recording agent is executed to a predetermined number of pages.

14. The process according to claim 10, wherein
the predetermined number of sheets is the number of pages from a page on which image formation on a special sheet is executed to a predetermined number of pages.

15. The process according to claim 10, further comprising performing continuous printing processing of all pages subjected to the printing when a specific printing condition is not satisfied.

16. The process according to claim 10, further comprising canceling the printing on the remaining pages when the predetermined continuation condition is not satisfied.

17. The process according to claim 16, further comprising determining that the predetermined continuation condition is not satisfied based on a cancellation command input.

18. The process according to claim 16, further comprising determining that the predetermined continuation condition is not satisfied based on a predetermined lapse time having been exceeded.
